(19) United States
(12) Patent Application Publication
(10) Pub. No.: US 2014/0269690 A1
(43) Pub. Date: Sep. 18, 2014

(54) NETWORK ELEMENT WITH DISTRIBUTED FLOW TABLES

(71) Applicant: QUALCOMM INCORPORATED, San Diego, CA (US)

(72) Inventor: Yifeng TU, Santa Clara, CA (US)

(73) Assignee: QUALCOMM INCORPORATED, San Diego, CA (US)

(21) Appl. No.: 13/802,358

(22) Filed: Mar. 13, 2013

(51) Int. Cl. H04L 12/70

(52) U.S. Cl. CPC H04L 47/10
USPC 370/389

(57) ABSTRACT

A network element is configured to store a plurality of flow table entries each having first and second portions, wherein the first portion can be read only and the second portion can be read and modified. The network element includes a first memory configured to store the first portion of the flow table entries and a second memory configured to store the second portion of the flow table entries. A plurality of processing cores are configured to process data packets in accordance with the flow table entries, each of the processing cores being further configured to access the first portion of the flow table entries in the first memory. A module is configured to exclusively access the second portion of the flow table entries in the second memory to support the processing of the data packets by the processing cores.

### BACKGROUND

1. Field

The present disclosure relates generally to electronic circuits, and more particularly, to network elements with distributed flow tables.

2. Background

Packet switched networks are widely used throughout the world to transmit information between individuals and organizations. In packet switched networks, small blocks of information, or data packets, are transmitted over a common channel interconnected by any number of network elements (e.g., a router, switch, bridge, or similar networking device.) Flow tables are used in these devices to direct the data packets through the network. In the past, these devices have been implemented as closed systems. More recently, programmable networks have been deployed which provide an open interface for remotely controlling the flow tables in the network elements. One example is OpenFlow, a specification based on a standardized interface to add, remove and modify flow table entries.

Network elements typically include a network processor designed specifically to process data packets. A network processor is a software programmable device that employs multiple processing cores with shared memory. Various methods may be used to manage access to the shared memory. By way of example, a processing core that requires access to a shared memory region may set a flag, thereby providing an indication to other processing cores that the shared memory region is locked. Another processing core that requires access to a locked memory region may remain idle condition until the flag is removed. This can degrade the overall throughput performance. When a large number of processing cores are competing for memory, the degradation in performance can be significant.

When OpenFlow, or other similar protocols, are implemented within a network element, it is desirable to protect the flow table entries during concurrent access without significantly increasing overhead.

### SUMMARY

One aspect of a network element is disclosed. The network element is configured to store a plurality of flow table entries each having first and second portions, wherein the first portion can be read only and the second portion can be read and modified. The network element includes a first memory configured to store the first portion of the flow table entries and a second memory configured to store the second portion of the flow table entries. The network element also includes a plurality of processing cores configured to process data packets in accordance with the flow table entries, each of the processing cores being further configured to access the first portion of the flow table entries in the first memory. A module is configured to exclusively access the second portion of the flow table entries in the second memory to support the processing of the data packets by the processing cores.

Another aspect of a network element is disclosed. The network element is configured to store a plurality of flow table entries each having first and second portions, wherein the first portion can be read only and the second portion can be read and modified. The network element includes first memory means for storing the first portion of the flow table entries and second memory means for storing the second portion of the flow table entries. The network element also includes a plurality of processing core means for processing data packets in accordance with the flow table entries, each of the processing core means being configured to access the first portion of the flow table entries in the first memory means. A module means is configured to exclusively access the second portion of the flow table entries in the second memory means and supporting the processing of the data packets by the processing core means.

One aspect of a method of managing a plurality of flow table entries is disclosed. Each of the flow table entries has first and second portions, the first portion of the flow table entries being stored in a first memory and the second portion of the flow table entries being stored in a second memory, wherein the first portion can be read only and the second portion can be read and modified. The method includes processing data packets with a plurality of processing cores in accordance with the flow table entries, each of the processing cores being configured to access the first portion of the flow table entries in the first memory. The method further includes accessing the second portion of the flow table entries in the second memory with a module to support the processing of the data packets by the processing cores.

One aspect of a computer program product is disclosed. The computer program product includes a non-transitory computer-readable medium comprising code executable by a plurality of processing cores and one or more modules in a network element. The network element is configured to store a plurality of flow table entries each having first and second portions, the first portion can be read only and the second portion can be read and modified. The network element further includes a first memory configured to store the first portion of the flow table entries and a second memory configured to store the second portion of the flow table entries. The code, when executed in the network element, causes the processing cores to process data packets in accordance with the flow table entries, wherein the processing cores process data packets by accessing the first portion of the flow table entries in the first memory. The code, when executed in the network element, further causes a module to exclusively access the second portion of the flow table entries in the second memory to support the processing of the data packets by the processing cores.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual block diagram illustrating an example of a telecommunications system.

FIG. 2 is a functional block diagram illustrating an example of a network element.

FIG. 3 is a conceptual diagram illustrating an example of a flow table entry in a lookup table.

FIG. 4 is a conceptual diagram illustrating an example of distributing a flow table entry in memory.

FIG. 5 is a flow diagram illustrating an example of the functionality of the network element.

FIG. 6A is a flow diagram illustrating an example of the functionality of the network element interface with the controller to add flow table entries to the lookup tables.

FIG. 6B is a flow diagram illustrating an example of the functionality of the network element interface with the controller to delete flow table entries from the lookup tables.

FIG. 6C is a flow diagram illustrating an example of the functionality of the network element interface with the controller to modify flow table entries in the lookup tables.

### DETAILED DESCRIPTION

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details However, it will be apparent to those skilled in the art that these concepts may be practiced without these specific details. In some instances, well known structures and components are shown in block diagram form in order to avoid obscuring the various concepts presented throughout this disclosure.

The various concepts presented throughout this disclosure are well suited for implementation in a network element. A network element (e.g., a router, switch, bridge, or similar networking device.) includes any networking equipment that communicatively interconnects other equipment on the network (e.g., other network elements, end stations, or similar networking devices). However, as those skilled in the art will readily appreciate, the various concepts disclosed herein may be extended to other applications.

These concepts may be implemented in hardware or software that is executed on a hardware platform. The hardware or hardware platform may be a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

FIG. 1 is a conceptual block diagram illustrating an example of a telecommunications system. The telecommunications system 100 may be implemented with a packet-based network that interconnects multiple user terminals. 103A, 103B. The packet-based network may be a wide area network (WAN) such as the Internet, a local area network (LAN) such as an Ethernet network, or any other suitable network. The packet-based network may be configured to cover any suitable region, including global, national, regional, municipal, or within a facility, or any other suitable region.

The packet-based network is shown with a network element 102. In practice, the packet-based network may have any number of network elements depending on the geographic coverage and other related factors. In the described embodiments, a single network element 102 will be described for clarity. The network element 102 may be a switch, a router, a bridge, or any other suitable device that interconnects other equipment on the network. The network element 102 may include a network processor 104 having one or more lookup tables. Each lookup table includes one or more flow table entries that are used to process data packets.

The network element 102 may be implemented as a programmable device which provides an open interface with a controller 108. The controller 108 may be configured to manage the network element 102. By way of example, the controller 108 may be configured to remotely control the lookup tables in the network element 102 using an open protocol, such as OpenFlow, or some other suitable protocol. A secure channel 106 may be established by the network element 102 with the controller 108 which allows commands and data packets to be sent between the two devices. In the described embodiment, the controller 108 can add, modify and delete flow table entries in the lookup tables, either proactively or reactively (i.e., in response to data packets).

FIG. 2 is a functional block diagram illustrating an example of a network element 106. The network element 106 is shown with two processing cores 204A, 204B, but may be configured with any number of processing cores depending on the particular application and the overall design constraints. In a manner to be described in greater detail later, the processing cores 204A, 204B provide a means for processing data packets in accordance with the flow table entries. The processing cores 204A, 204B may have access to shared memory 208 through a memory controller 207 and memory arbiter 206. In this example, the shared memory 208 consists of two static random access memory (SRAM) banks 208A, 208B, but may be implemented with any other suitable storage device in any other suitable single or multiple memory bank arrangement. The SRAM banks 208A, 208B may be used to store program code, lookup tables, data packets, and/or other information.

The memory arbiter 206 is configured to manage access by the processing cores 204A, 204B to the shared memory 208. By way of example, a processing core seeking access to the shared memory 208, may broadcast a read or write request to the memory arbiter 206. The memory arbiter 206 may then grant the requesting processing core access to the shared memory 208 to perform the read or write operation. In the event that multiple read and/or write requests from one or more processing cores contend at the memory arbiter 206, the memory arbiter 206 may then determine the sequence in which the read and/or write operations will be performed.

Various processing applications performed by the processing cores 204A, 204B may require exclusive access to an SRAM bank, or alternatively, a memory region within the SRAM bank or distributed across the SRAM banks. As explained earlier in the background portion of the disclosure, a flag may be used that is indicative of the accessibility or non-accessibility of a shared memory region. A processing core that seeks exclusive access to a shared memory region can read the flag to determine the accessibility of the shared memory region. If the flag indicates that the shared memory region is available for access, then the memory controller 207 may set the flag to indicate that the shared memory region is “locked,” and the processing core may proceed to access the shared memory region. During the locked state, the other processing core is not able to access the shared memory region. Upon completion of the processing operation, the flag is removed by the memory controller 207 and the shared memory region returns to an unlocked state.

The network element 106 is also shown with a dispatch module 202 and a reorder module 210. These modules provide a network interface for the network element 106. The data packets enter the network element 106 at the dispatch module 202. The dispatch module 202 distributes the data packets to the processing cores 204A, 204B for processing. The dispatch module 202 may also assign a sequence number to every data packet. The reorder module 210 retrieves the processed data packets from the processing cores 204A, 204B. The sequence numbers may be used by the reorder module 210 to output the data packets to the network in the order that they are received by the dispatch module 202.

The processing cores 204A, 204B are configured to process data packets based on the flow table entries in the lookup tables stored in the shared memory 208. Each flow table entry includes a set of matched fields against which data packets are matched, a priority field for matching precedence, a set of counters to track data packets, and a set of instructions to apply. FIG. 3 is a conceptual diagram illustrating an example of a flow entry in a lookup table. In this example, the matched fields may include various data packet header fields such as the IP source address 302, the IP destination address 304, and the protocol (e.g., TCP, UDP, etc.) 306. Following the matched fields are a data packet counter 308, duration counter 310, a priority field 312, a timeout value counter 314, and an instruction set 316.

A flow table entry is identified by its matched fields and priority. When a data packet is received by a processing core, certain matched fields in the data packet are extracted and compared to the flow table entries in a first one of the lookup tables. A data packet matches a flow table entry if the matched fields in the data packet matches those in the flow table entry. If a match is found, the counters associated with that entry are updated and the instruction set included in that entry is applied to the data packet. The instruction set may either direct the data packet to another flow table, or alternatively, direct the data packet to the reorder module for outputting to the network. A set of actions associated with the data packet is accumulated while the data packet is processed by each flow table and is executed when the instruction set directs the data packet to the reorder module.

A data packet received by a processing core that does not match a flow table entry is referred to as a “table miss.” A table miss may be handled in a variety of ways. By way of example, the data packet may be dropped, sent to another flow table, forwarded to the controller, or subject to some other processing.

The network element 106 is also shown with an application programming interface (API) 212. The API 212 may include a protocol stack running on a separate processor. The protocol stack is responsible for establishing a secure channel with the controller 108 (see FIG. 1). The secure channel may be used to send commands and data packets between the network element 106 and the controller. In a manner to be described in greater detail later, the controller may also use the secure channel to add, modify and delete flow table entries in the lookup tables.

As discussed earlier in the background portion of this disclosure, the network element may experience a significant degradation in performance when a large number of processing cores are competing for memory resources. Various methods may be used to minimize the impact on performance. In one embodiment, each table flow entry in the lookup tables is distributed across multiple memory regions. Specifically, each flow table entry is partitioned into a first portion comprising read only fields and a second portion comprising read/write fields. In this embodiment, the first SRAM bank 208A provides a means for storing the first portion of the flow table entries and the second SRAM bank 208B provides a means for storing the second portion of the flow table entries. FIG. 4 is a conceptual diagram illustrating an example of distributing the flow table entries in this fashion. Each flow table entry in the first SRAM bank 208A includes the IP source address 302, the IP destination address 304, the protocol 306, the priority field 312, the instruction set 316, and a pointer 318. The pointer 318 is used to identify the location of the corresponding read/write fields in the second SRAM bank 208B. The read/write fields include the packet counter 308, the duration counter 310, the timeout value 314, and a valid flag 320.

Returning to FIG. 2, the processing cores 204A, 204B have access to the read only fields of the flow table entries in the first SRAM bank 208A, but do not need to access to the read/write fields of the flow table entries in the second SRAM bank 208B. In this embodiment, the reorder module 210 provides a means for exclusively accessing the read/write field of the flow table entries in the second SRAM bank 208B. In an alternative embodiment, the dispatch module 202, or a separate module in the network element 106, may be used to exclusively access the read/write fields of the flow table entries in the second SRAM bank 208B. The separate module may perform other functions as well, or may be dedicated to managing flow table entries in the second SRAM bank 208B. Preferably, a single module, whether it be the dispatch module, the reorder module, or another module, has exclusive access to the read/write fields of the flow table entries in the second SRAM bank 208B to avoid the need for a locking mechanism which could degrade the performance of the network element 106.

FIG. 5 is a flow diagram illustrating an example of the functionality of the network element. Consistent with the description above, the functionality may be implemented in hardware or software. The software may be stored on a computer-readable medium and executable by the processing cores and one or more modules residing in the network element. The computer-readable medium may be one or both SRAM banks. Alternatively, the computer-readable medium may be any other non-transitory medium that can store software and be accessed by the processing cores and modules.

In operation, the dispatch module receives data packets from the network and distributes the data packets to either the first processing core 204A or the second processing core 204B through a dispatching algorithm that attempts to balance the load between the two processing cores 204A, 204B. Each processing core 204A, 204B is responsible for processing the data packets it receives from the dispatch module 202 in accordance with the flow table entries in the lookup tables.

Turning to FIG. 5, a data packet is received by the dispatch module and distributed to one of the processing cores in block 502. In block 504, the processing core compares the matched fields extracted from the data packets it receives with the flow table entries in the first SRAM bank. If, in block 506, a match is found, the processing core, in block 508 applies the instruction set to the data packet and forwards the pointer to the reorder module. In block 510, the reorder module uses the pointer to update the counters and timeout value for the corresponding flow table entry in the second SRAM bank. If, on the other hand, the data packet received by the processing core that does not match a flow table entry in the first SRAM bank, the data packet may be processed as a table miss in block 512. That is, the data packet may be sent to another flow table, forwarded to the controller, or subject to some other processing.

As described earlier in connection with FIG. 1, the controller is responsible for adding, deleting and modifying flow table entries through a secure channel established with the network element. The API 212 is responsible for managing the lookup tables in response to commands from the controller. The API 212 manages the lookup tables through the dispatch module 202 and the reorder module 212. In one embodiment of a network element 106, the dispatch module 202 provides a means for adding and deleting the portions of the flow table entries stored in the first SRAM bank 208A and the reorder module 212 provides a means for adding, deleting and modifying the portions of the flow table entries stored in the second SRAM bank 208B. Alternatively, the dispatch module 202, the reorder module 212, another module (not shown) in the network element 106, or any combination thereof may be used to add, delete and modify flow table entries.

FIGS. 6A-6C are flow diagrams illustrating examples of the functionality of the network element interface with the controller. Consistent with the description above, the functionality may be implemented in hardware or software. The software may be stored on a computer-readable medium and executable by the API, the processing cores, and one or more modules residing in the network element. The computer-readable medium may be one or both SRAM banks. Alternatively, the computer-readable medium may be any other non-transitory medium that can store software and be accessed by the processing cores and modules.

Turning to FIG. 6A, the API adds a flow table entry by sending an “add” message to the dispatch module in block 602. The dispatch module computes the index in the lookup table in block 604 based on hash keys of the matched fields, or by some other suitable means. In block 606, the dispatch module allocates memory for the flow table entry in both the first and second SRAM banks. In block 608, the dispatch module writes the read only fields of the flow table entry into the first SRAM bank and appends to the read only fields a pointer to a location in the second SRAM bank where the read/write fields for the corresponding flow table entry will be stored. In block 610, the dispatch module forwards the pointer to the reorder module. In block 612, the reorder module then sets the counters, timeout value, and the valid flag at the memory location in the second SRAM bank identified by the pointer.

Turning to FIG. 6B, the API may delete a flow table entry by sending a “delete” message to the dispatch module in block 622. The flow table entry is identified in the message by its matched fields and priority. In block 624, the dispatch module compares the matched fields and the priority contained in the “delete” message with the flow table entries in the first SRAM bank. If, in block 626, a match is found, the dispatch module, in block 628, deletes that portion of the flow table entry (i.e., the read only fields) from the first SRAM bank and forwards the pointer to the reorder module. In block 630, the reorder module uses the pointer to locate the corresponding read/write fields (i.e., counters, timeout value, and valid flag) in the second SRAM bank and deletes the read/write fields. If, on the other hand, a match is not found in block 626, then a table miss message may be may be sent back to the controller in block 632 via the API.

Lastly, tuning to FIG. 6C, the API may modify flow table entries by sending a “modify” message to the dispatch module in block 642. The flow table entry is identified in the message by its matched fields and priority. In block 644, the dispatch module compares the matched fields and the priority contained in the “modify” message with the flow table entries in the first SRAM bank. If, in block 646, a match is found, the dispatch module, in block 648 forwards the modification message and the pointer to the reorder module. In block 650, the reorder module uses the pointer to locate the corresponding read/write fields (i.e., counters, timeout value, and valid flag) in the second SRAM bank and modifies the read/write fields in accordance with the modification message. If, on the other hand, a match is not found in block 646, then a table miss message may be may be sent back to the controller in block 652 via the API.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A network element configured to store a plurality of flow table entries each having first and second portions, wherein the first portion can only be read and the second portion can be read and modified, the network element comprising:
a first memory configured to store the first portion of the flow table entries;
a second memory configured to store the second portion of the flow table entries;
a plurality of processing cores configured to process data packets in accordance with the flow table entries, each of the processing cores being further configured to access the first portion of the flow table entries in the first memory; and
a module configured to exclusively access the second portion of the flow table entries in the second memory to support the processing of the data packets by the processing cores.

2. The network element of claim 1 wherein the first memory is further configured to store, with the first portion of each flow table entry, a pointer to the corresponding second portion of the flow table entry stored in the second memory.

3. The network element of claim 2 wherein the processing cores are further configured to provide the pointers stored in the first memory to the module to enable the module to support the processing of the data packets.

4. The network element of claim 1 wherein the module is further configured to modify the second portion of the flow table entries stored in the second memory.

5. The network element of claim 1 further comprising a second module configured to add a first portion of a flow table entry to the first memory and further configured to remove the first portion of any flow table entry from the first memory.

6. The network element of claim 5 wherein the module is further configured to add a second portion of a flow table entry to the second memory when the first portion of that flow table entry is added to the first memory and further configured to remove the second portion of any of flow table entry from the second memory whose first portion of that flow table entry has been removed from the first memory.

7. A network element configured to store a plurality of flow table entries each having first and second portions, wherein the first portion can only be read and the second portion can be read and modified, the network element comprising:
first memory means for storing the first portion of the flow table entries;
second memory means for storing the second portion of the flow table entries;
a plurality of processing core means for processing data packets in accordance with the flow table entries, each of the processing core means being configured to access the first portion of the flow table entries in the first memory means; and
module means for exclusively accessing the second portion of the flow table entries in the second memory means to support the processing of the data packets by the processing core means.

8. The network element of claim 7 wherein the first memory means is configured to store with the first portion of each flow table entry a pointer to the corresponding second portion of such flow table entry stored in the second memory means.

9. The network element of claim 8 wherein the processing core means are further configured to provide the pointers stored in the first memory means to the module means to enable the module means to support the processing of the data packets.

10. The network element of claim 7 wherein the module means is further configured to modify the second portion of the flow table entries stored in the second memory means.

11. The network element of claim 7 further comprising second module means for adding a first portion of a flow table entry to the first memory means, and for removing the first portion of any flow table entry from the first memory means.

12. The network element of claim 11 wherein the module means is configured to add a second portion of a flow table entry to the second memory means when the first portion of that flow table entry is added to the first memory means and remove the second portion of any flow table entry from the second memory means whose first portion of that flow table entry has been removed from the first memory means.

13. A method of managing a plurality of flow table entries, each having first and second portions, the first portion of the flow table entries being stored in a first memory and the second portion of the flow table entries being stored in a first memory, wherein the first portion can only be read and the second portion can be read and modified, the method comprising:
processing data packets with a plurality of processing cores in accordance with the flow table entries, each of the processing cores being configured to access the first portion of the flow table entries in the first memory; and
exclusively accessing the second portion of the flow table entries in the second memory with a module and supporting with the module the processing of the data packets by the processing cores.

14. The method of claim 13 wherein the first memory is further configured to store with the first portion of each flow table entry a pointer to the corresponding second portion of such flow table entry stored in the second memory.

15. The method of claim 14 further comprising providing, with the processing cores, the pointers stored in the first memory to the module to enable the module to support of the processing of the data packets by the processing cores.

16. The method of claim 13 further comprising modifying the second portion of the flow table entries stored in the second memory with the module.

17. The method of claim 13 further comprising adding a first portion of a flow table entry to the first memory with a second module and removing the first portion of any flow table entry from the first memory with the second module.

18. The method of claim 17 further comprising adding a second portion of a flow table entry to the second memory with the module when the first portion of that flow table entry is added to the first memory and removing the second portion of any flow table entry from the second memory with the module whose first portion of that flow table entry has been removed from the first memory.

19. A computer program product, comprising:
a non-transitory computer-readable medium comprising code executable by a plurality of processing cores and one or more modules in a network element, the network element being configured to store a plurality of flow table entries each having first and second portions, the first portion can be read only and the second portion can be read and modified, wherein the network element further comprises a first memory configured to store the first portion of the flow table entries and a second memory configured to store the second portion of the flow table entries, and wherein the code, when executed in the network element, causes:
the processing cores to process data packets in accordance with the flow table entries, wherein the processing cores access the first portion of the flow table entries in the first memory; and
a module to exclusively access the second portion of the flow table entries in the second memory to support the processing of the data packets.

20. The computer program product of claim 19 wherein the first memory is further configured to store with the first portion of each flow table entry a pointer to the corresponding second portion of such flow table entry stored in the second memory.

21. The computer program product of claim 20 wherein the code, when executed in the network element, further causes the processing cores to provide the pointers stored in the first memory to the module to enable the module to support of the processing of the data packets by the processing cores.

22. The computer program product of claim 19 wherein the code, when executed in the network element, further causes the module to modify the second portion of the flow table entries stored in the second memory.

23. The computer program product of claim 19 wherein the code, when executed in the network element, further causes a second module to add a first portion of a flow table entry to the first memory and remove the first portion of any flow table entry from the first memory.

24. The computer program product of claim 23 wherein the code, when executed in the network element, further causes the module to add a second portion of a flow table entry to the second memory when the first portion of that flow table entry is added to the first memory and remove the second portion of any flow table entry from the second memory whose first portion of that flow table entry has been removed from the first memory.
